(19) United States
(12) Patent Application Publication
(10) Pub. No.: US 2015/0062468 A1
(43) Pub. Date: Mar. 5, 2015

(54) TOUCH SCREEN STRUCTURE

(71) Applicant: Touchplus Information Corp., New Taipei City (TW)

(72) Inventor: SHIH-HSIEN HU, NEW TAIPEI CITY (TW)

(21) Appl. No.: 14/473,291

(22) Filed: Aug. 29, 2014

Related U.S. Application Data
(60) Provisional application No. 61/871,983, filed on Aug. 30, 2013.

(51) Int. Cl. G06F 3/044; G02F 1/1335; G02F 1/1333; G06F 3/041; G06F 1/16

(52) U.S. Cl. CPC G06F 3/044; G06F 3/0412; G06F 1/1643; G02F 1/13338; G02F 1/133512; G02F 1/1336
USPC 349/12

(57) ABSTRACT

A touch screen structure is provided. The touch screen structure includes a display module, a transparent conductive member and a control circuit. The display module has a transparent substrate. The transparent conductive member is formed on a surface of the transparent substrate for providing a single layer capacitive touch panel having sensor pads. A space between any two adjacent sensor pads is greater than or equal to 100 μm. The control circuit is electrically connected to the sensor pads for controlling the single layer capacitive touch panel.

### FIELD OF THE INVENTION

The present disclosure relates to a display device, and particularly to a touch screen structure.

### BACKGROUND OF THE INVENTION

With rapid development of touch sensing technology, many electronic apparatuses such as mobile phones, notebook computers or tablet computers take advantage of touch devices to provide intuitive operation and easy human-machine interface. These electronic apparatuses hugely enter modern lives and great business opportunities are created. There are two known touch sensing technologies, i.e. capacitive sensing and resistive sensing.

For capacitive sensing, when the touch device is touched with a human finger or a conductive object, a capacitor is temporarily formed on the electrode corresponding to the touched position. Therefore, equivalent capacitance of the corresponding electrode changes. A sensor circuit can determine the touched position on the touch device according to the equivalent capacitance change of the corresponding electrode.

For resistive sensing, when an object such a finger or a stylus presses down onto a surface of the touch device, the upper electrode and the lower electrode are electrically connected at the pressed position so that the electrodes behave as a voltage divider circuit. Therefore, the sensor circuit can determine the pressed position on the touch device according to the voltage change of the upper electrode and the lower electrode.

Since large-area flat-panel display gains popularity now and touch sensing technology is widely used as a most friendly human-machine interface, there is an increased demand for large-area touch screen these days. In a conventional manufacturing process of the touch screen, a touch module and a display module are produced separately, and then the touch module is tightly attached to or laminated on the display module. However, large area of the touch screen usually leads to several problems such as misalignment of the touch module in the lamination or attachment procedure. Therefore, a touch screen structure which can avoid the problems is desired.

### SUMMARY OF THE INVENTION

An aspect of the present disclosure provides a touch screen structure. The touch screen structure includes a display module, a transparent conductive member and a control circuit. The display module has a transparent substrate. The transparent conductive member is formed on a surface of the transparent substrate for providing a single layer capacitive touch panel having sensor pads. A space between two adjacent sensor pads is greater than or equal to 100 μm. The control circuit is electrically connected to the sensor pads for controlling the single layer capacitive touch panel.

In an embodiment, the single capacitive touch panel includes a connecting element electrically connected to the sensor pads and the control circuit.

In an embodiment, the connecting element includes connecting traces formed from the transparent conductive member for electrically connecting the sensor pads and the control circuit. Spacing between the connecting traces is greater than or equal to 100 μm.

In an embodiment, the touch screen structure includes a cover lens. The transparent conductive member is disposed between the cover lens and the transparent substrate. Air or a dielectric material exists in a gap between the cover lens and the transparent conductive member.

In an embodiment, the gap between the cover lens and the transparent conductive member has a thickness of 0.1 mm-5 mm.

In an embodiment, the transparent substrate is a glass substrate and the transparent conductive member is made of an indium tin oxide material, a transparent conductive oxide material, a conductive polymer material, a conductive ink or a conductive liquid material.

In an embodiment, the touch screen structure includes a polarizing layer covering the transparent conductive member.

Another aspect of the present disclosure provides a touch screen structure. The touch screen structure includes a display module, a transparent conductive member and a control circuit. The display module has a transparent substrate. The transparent conductive member is formed on a surface of the transparent substrate for providing a single layer capacitive touch panel having sensor pads and connecting traces. The connecting traces are electrically connected to the sensor pads. A space between two adjacent sensor pads is greater than or equal to 100 μm. The control circuit is electrically connected to the sensor pads for controlling the single layer capacitive touch panel.

In an embodiment, spacing between the connecting traces is greater than or equal to 100 μm.

Another aspect of the present disclosure provides a touch screen structure. The touch screen structure includes a display module, a transparent conductive member and a control circuit. The display module has a transparent substrate including an extending region. The transparent conductive member is formed on a surface of the transparent substrate for providing a single layer capacitive touch panel having sensor pads and connecting traces, which extend to the extending region. The control circuit is disposed at the extending region and electrically connected to the sensor pads through the connecting traces for controlling the single layer capacitive touch panel.

Another aspect of the present disclosure provides a touch screen structure. The touch screen structure includes a display module, a single layer capacitive touch panel and a control circuit. The display module has pixel units and a shielding area disposed between any two adjacent pixel units. The single layer capacitive touch panel has sensor pads and a connecting element on a specific surface. The connecting element is electrically connected to the sensor pads. The control circuit is electrically connected to the sensor pads for controlling the single layer capacitive touch panel. Edges of the sensor pads and/or the connecting element are arranged in the shielding area.

In an embodiment, the sensor pads and the connecting element are formed from a transparent conductive member.

Another aspect of the present disclosure provides a touch screen structure. The touch screen structure includes a backlight module, a display module, a conductive member and a control circuit. The display module is disposed relative to the backlight module. The conductive member is formed on a surface of the backlight module for providing a portion of a capacitive touch panel. The control circuit is electrically connected to the capacitive touch panel for controlling the capacitive touch panel.

In an embodiment, the conductive member is a transparent conductive member disposed between the backlight module and the display module.

In an embodiment, the conductive member is an opaque conductive member, and the backlight module is disposed between the conductive member and the display module.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a schematic diagram illustrating a touch screen structure according to an embodiment of the present invention;

FIG. 2 is a schematic diagram illustrating a single layer capacitive touch panel of the touch screen structure;

FIG. 3 is a top view illustrating arrangement of sensor pads and connecting traces of the single layer capacitive touch panel;

FIG. 4 is a schematic diagram illustrating a touch screen structure according to another embodiment of the present invention;

FIGS. 5A-5C illustrate another single layer capacitive touch panel of the touch screen structure according to the present disclosure;

FIG. 6 is a schematic diagram illustrating dimensions of a sensing cell and a capacitor of the single layer capacitive touch panel in FIGS. 5A-5C; and

FIGS. 7A and 7B illustrate portions of a further single layer capacitive touch panel of the touch screen structure according to the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

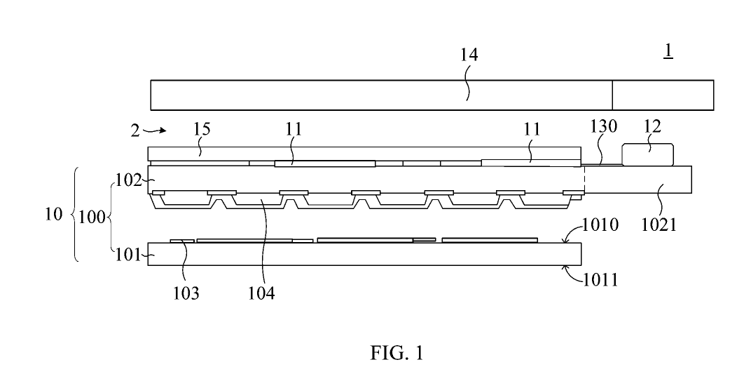

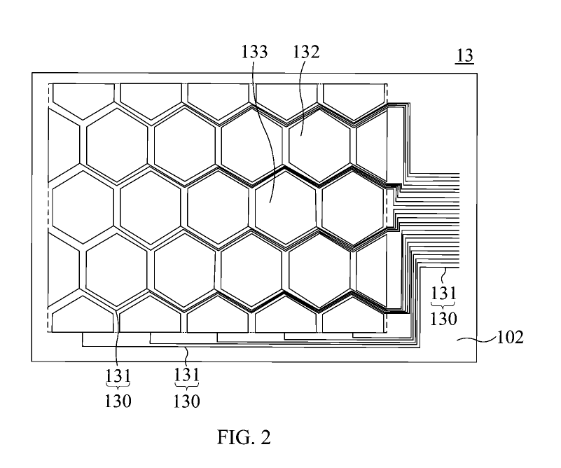

Please refer to FIG. 1, a schematic diagram illustrating a touch screen structure according to an embodiment of the present invention. The touch screen structure 1 is a flat-panel display (e.g. LCD display) with touch sensing function. The touch screen structure 1 includes a display module 10, a transparent conductive member 11, a control circuit 12 and a capacitive touch panel (as shown in FIG. 2). The display module 10 includes a transparent substrate 100. In the embodiment, the transparent substrate 100 includes a lower glass substrate 101 and an upper glass substrate 102. There are thin film transistors (TFT) 103 formed on a surface 1010 of the lower glass substrate 101. In addition, color filters 104 are formed on a surface of the upper glass substrate 102.

For example, the transparent conductive member 11 is formed on another surface of the upper glass substrate 102 by a semiconductor process such as a photolithography and etching process. A single layer capacitive touch panel 13 having many sensor pads 132 which is formed by such semiconductor process is shown in FIG. 2. In an embodiment, the transparent conductive member 11 may be a transparent conductive layer made of metal, nonmetal, nanomaterial, whisker material, etc. In other embodiments, the transparent conductive member 11 is formed by a screen printing method with low cost. Two screen printing methods are given here for illustration purpose. In the first screen printing method, at first, a transparent conductive material such as an indium tin oxide (ITO) material or a transparent conductive oxide (TCO) material is formed on the upper glass substrate 102. Then, an etching paste with patterns is transferred onto the transparent conductive material. Reaction between the etching paste and the transparent conductive material occurs. Finally, the etching paste and the reacted transparent conductive material are washed out, and the left transparent conductive material (e.g. ITO material or TCO material) forms the transparent conductive member 11. In general, the smallest line width of the transparent conductive member 11 reaches 100 μm-150 μm when the etching paste is used in the screen printing method. In the second screen printing method, a conductive polymer material, a conductive ink or a conductive liquid material is directly printed onto the upper glass substrate 102 to form a pattern of the transparent conductive member 11. The smallest line width of the transparent conductive member 11 is determined according to the printed material, for example, 100 μm-150 μm for a conductive polymer material.

Although the transparent conductive member 11 of the single layer capacitive touch panel 13 is formed on the upper glass substrate 102, it is not intended to limit thereto. For example, the transparent conductive member 11 may be formed on a surface 1011 of the lower glass substrate 101.

Please refer to FIG. 2, a schematic diagram illustrating a single layer capacitive touch panel of the touch screen structure. The single capacitive touch panel 13 includes many sensor pads 132 and a connecting element 130 on the upper glass substrate 102. The sensor pads 132 are separately disposed on the upper glass substrate 102 and electrically isolated from one other. Some of the sensor pads 132 are hexagonal or regular hexagonal sensor pads. For some hexagonal sensor pads 133, each of them is surrounded by six nearby sensor pads 132. In FIG. 2, the hexagonal sensor pads 132 are regularly arranged. The sensor pads 132 at edges of the upper glass substrate 102 are not entirely surrounded by other sensor pads 132 and there are less than six nearby sensor pads 132. The space between any two adjacent sensor pads 132 may be greater than or equal to 100 μm. Low cost screen printing method is sufficient to form the transparent conductive member 11, and it is not required to take advantage of precision photolithography and etching process to form fine space. Increasing an area of the sensor pads 132 or grouping the sensor pads 132 can increase a sensible distance for floating touch between the single layer capacitive touch panel 13 and the human finger, palm or conductive object.

Please refer to FIG. 1 and FIG. 2 again. The connecting element 130 is electrically connected to the sensor pads 132 and the control circuit 12. The connecting element 130 may include, but is not limited to, connecting traces, a flexible printed circuit (FPC), a flexible printed circuit assembly (FPCA) or a combination thereof. In an embodiment, the connecting element 130 includes several connecting traces electrically connected to respective sensor pads 132. In another embodiment, the connecting element 130 further includes a flexible printed circuit or a flexible printed circuit assembly to replace and omit several connecting traces.

In an embodiment as shown in FIG. 2, the connecting element 130 is implemented by connecting traces 131 disposed on the upper glass substrate 102. Each connecting trace 131 is electrically connected to a corresponding sensor pad 132. There is one-to-one correspondence between the connecting traces 131 and the sensor pads 132. The sensor pads 132 and the corresponding connecting traces 131 may be made of the same material through the same formation process. In another embodiment, the sensor pads 132 and the corresponding connecting traces 131 are made of different materials or formed through different formation processes. As described above, the connecting traces 131 and the sensor pads 132 may be formed by a screen printing method and the spacing between the connecting traces 131 is greater than or equal to 100 μm.

Please refer back to FIG. 1, the upper glass substrate 102 of the transparent substrate 100 may have an extending region 1021 more than the lower glass substrate 101. The control circuit 12 is disposed at the extending region 1021 and electrically connected to the sensor pads 132 through the connecting element 130 which extends to the extending region 1021.

The touch screen structure 1 may further include a cover lens 14. The material of the cover lens 14 may be, but is not limited to, glass material. According to this design, the transparent conductive member 11 is disposed between the cover lens 14 and the upper glass substrate 102 of the transparent substrate 100. A gap 2 between the cover lens 14 and the upper glass substrate 102 of the transparent substrate 100 is filled with air or other dielectric material. The gap 2 has a thickness about 0.1 mm-5 mm. The user may touch the cover lens 14 to perform a control action through proximity sensing. Since the cover lens 14 configured to protect the transparent conductive member 11 is not tightly attached to/laminated on or even does not touch the upper glass substrate 102, the problems such as misalignment of the touch module occurring in the attachment or lamination procedure are avoided so that the production yield of the touch screen structure 1 is highly improved, especially for large-area display.

In an embodiment, the touch screen structure 1 may further include a polarizing layer 15 with a thickness about 1.5 μm-2 μm covering the transparent conductive member 11. The polarizing layer 15 is formed on the transparent conductive member 11 before assembly of the cover lens 14. Air or other dielectric material exists in the gap 2 between the cover lens 14 and the polarizing layer 15.

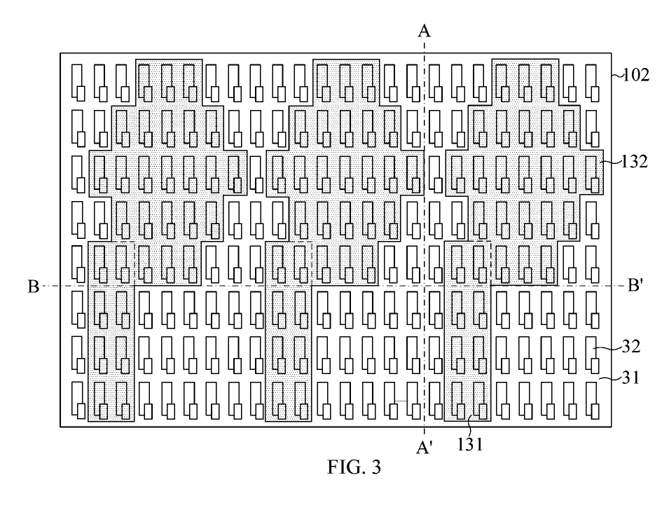

Please refer to FIG. 3, a top view illustrating arrangement of sensor pads and connecting traces of the single layer capacitive touch panel. The upper glass substrate 102 of the display module 10 includes pixel units 32 and a shielding area 31. Since tilt angles of the liquid crystal molecules at edges of the pixel units 32 can not be well controlled, the shielding area 31 is set to hide the liquid crystal molecules at the edges of the pixel units 32. The shielding area 31 is usually located between two adjacent pixel units 32. In this example, the shielding area 31 includes a black matrix for shielding light. In an embodiment, edges of the sensor pads 132 and the connecting element 130 are also arranged in the shielding area 31 to prevent from being seen.

For example, the edges of the sensor pads 132 and the connecting traces 131 are arranged at an area covered by the black matrix. As shown in FIG. 3, the edges of the sensor pads 132 and the connecting traces 131 are aligned with central lines (e.g. line A-A′ or line B-B′) of shielding parts of the shielding area 31 wherein each shielding part is defined by two adjacent sensor pads 132. Layout of the sensor pads 132, the connecting traces 131 and relative wiring can be designed according to the arrangement of the pixel units 32. In fact, it is not necessary that the edges of the sensor pads 132 and the connecting traces 131 are aligned with the central lines of the shielding parts of the shielding area 31, and their positions can be adjusted in different applications. Thus, light passing the edges of the sensor pads 132 and the connecting traces 131 is minimized to prevent the viewers from recognizing the sensor pads 132 and the connecting traces 131.

As described above, in the touch screen structure 1 of the present disclosure, the transparent conductive member 11 is directly formed on the surface of the transparent substrate 10 to function as a single layer capacitive touch panel 13 including sensor pads 132. The problems such as misalignment of the touch module occurring in the attachment or lamination procedure are avoided. Furthermore, since air or other dielectric material is provided in the gap 2 between the cover lens 14 and the transparent conductive member 11, the cover lens 14 for protecting the sensor pads 132 is not tightly attached to/laminated on the upper glass substrate 102 so that the production yield of the touch screen structure 1 is improved.

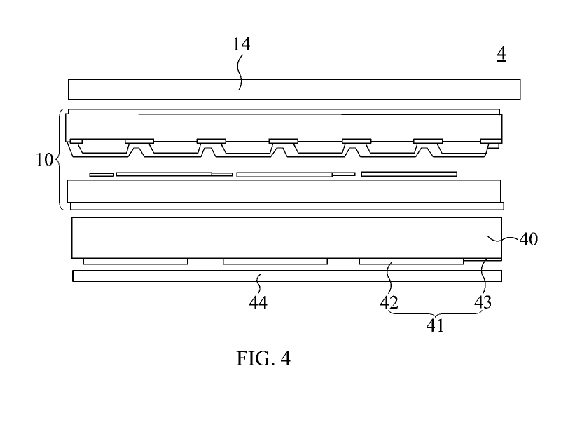

According to the present disclosure, it is to be noted that the transparent conductive member is not limited to be formed on the surface of the upper glass substrate. Please refer to FIG. 4, a schematic diagram illustrating a touch screen structure according to another embodiment of the present invention. The touch screen structure 4 includes a display module 10, a backlight module 40, a conductive member 41, a back plate 44, a capacitive touch panel (not shown) and a control circuit (not shown). In the embodiment, the conductive member 41 is formed on a surface of the backlight module 40. The backlight module 40 is disposed between the conductive member 41 and the display module 10. The conductive member 41 forms a single layer capacitive touch panel (not shown) including many sensor pads 42 and a connecting element 43. The structure of the capacitive touch panel and the arrangement of the control circuit are similar to those described with reference to FIG. 1 and FIG. 2.

In this embodiment, since the sensor pads 42 and the connecting element 43 are disposed on a back surface of the backlight module 40, the material of the sensor pads 42 and the connecting element 43 may be made of opaque material, e.g. better conductive material such as metal. Increasing an area of the sensor pads 42 or grouping the sensor pads 42 can increase a sensible distance for floating touch between the single layer capacitive touch panel and the human finger, palm or conductive object. By this method, even if user's finger or the conductive object does not directly touch the sensor pads 42, or the sensor pads 42 are located under the display module 10 and the backlight module 40, the touch sensing function is still operable. Please refer to US 2014/0083834 and US 2014/0035865 for the relative description. However, it is not intended to limit the conductive member 41 to be made of the opaque conductive material. If the conductive member 41 is made of a transparent conductive material, the conductive member 41 may be formed on a front surface (a surface near the display module 10) of the backlight module 40 rather than a back surface (a surface far from the display module 10) of the backlight module 40. In other words, the conductive member 41 is disposed between the backlight module 40 and the display module 10.

Furthermore, the present disclosure can be applied to other capacitive touch panel instead of the single layer capacitive touch panel. For example, for a two dimensional or a 1.5 dimensional (1.5D) capacitive touch panel (not shown), entire capacitor electrodes or a portion of capacitor electrodes of the capacitive touch panel and corresponding signal input/output lines may be formed on either the front surface or the back surface of the backlight module 40. The 1.5 dimensional structure will be described in detail in the following paragraphs.

It is to be noted that although the touch screen structure 4 includes a cover lens 14 at the front side as shown in FIG. 4, it is not necessary to provide the cover lens. Alternatively, the user may touch the back plate 44 of the touch screen structure 4 for touch sensing. Therefore, the design flexibility of the touch screen structure is increased.

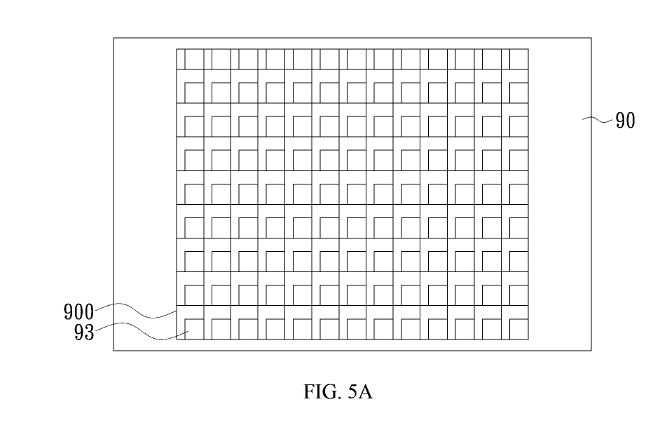

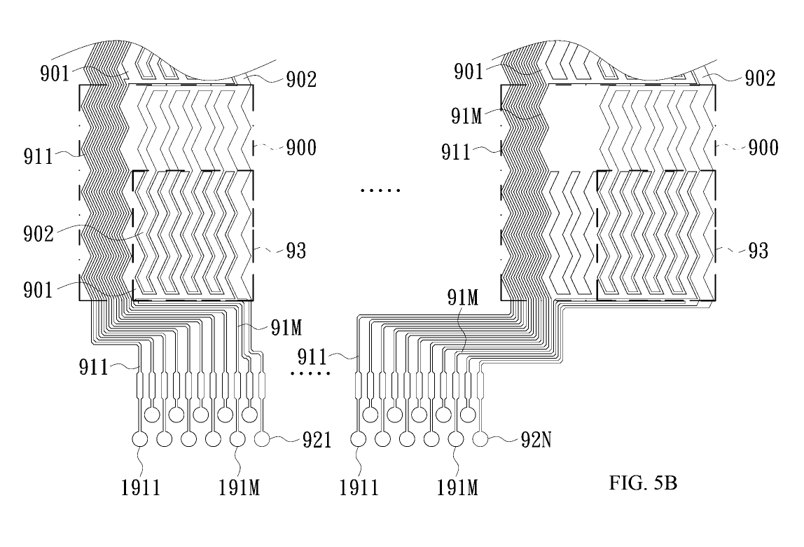

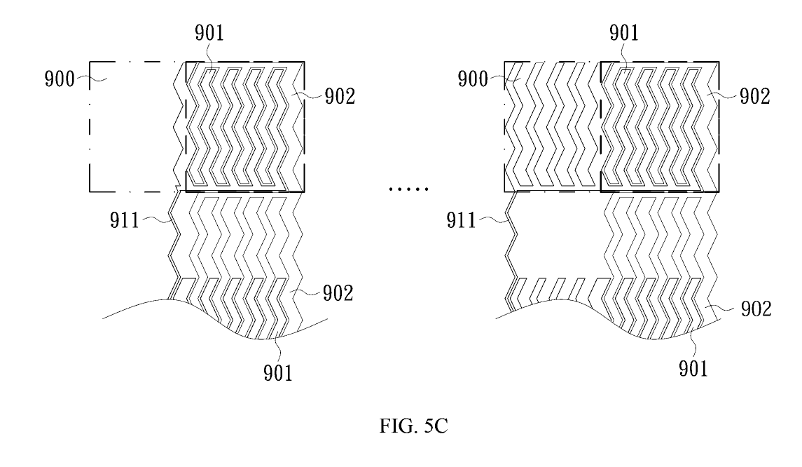

Please refer to FIGS. 5A-5C illustrating another single layer capacitive touch panel of the touch screen structure according to the present disclosure. In this embodiment, a 1.5 dimensional (1.5D) structure is shown. In FIG. 5A, there are M*N sensing cells 900 on the substrate 90, and they are arranged in an M*N matrix (e.g. M=9 and N=13). Each of the sensing cells 900 has a corresponding capacitor 93. Most of the capacitors 93 have a smaller area than the sensing cells 900. For example, the area fraction of the capacitors 93 to the sensing cells 900 is about ½-⅓.

FIGS. 5B and 5C only illustrate portions, i.e. sensing cells 900 at four corners of the single layer capacitive touch panel. Each sensing cell 900 has a first capacitor electrode 901, total M*N first capacitor electrodes 901 (e.g. 9*13 first capacitor electrodes 901) in the capacitive touch panel. The first capacitor electrodes 901 are formed on a surface of the substrate 90. For the same column in the M*N matrix, M first capacitor electrodes 901 are connected to respective signal lines 911-91M, which form a signal line group. Hence, for N columns in the capacitive touch panel, there are total N signal line groups. Further, the signal lines 911-91M with the same serial number (i.e. the signal lines for the first capacitor electrodes 901 in the same row) are electrically connected in parallel (not shown) so that N signal lines for the N first capacitor electrodes in the same row is integrated to a first signal input/output terminal. Hence, for M rows, there are M first signal input/output terminals 1911-191M.

Furthermore, M*N second electrodes 902 are formed on the same surface of the substrate 90. For the same column, M second electrodes 902 are electrically connected to a second signal input/output terminal. Hence, for N columns, there are N second signal input/output terminals 921-92N. According to this arrangement, every one of the first capacitor electrodes 901 and adjacent second capacitor electrode 902 forms a capacitor 93, total M*N capacitors 93 in the capacitive touch panel. The M first signal input/output terminals 1911-191M and the N second signal input/output terminals 921-92N may be connected to signal input lines and signal output lines, respectively, or vice versa.

In the embodiment as shown in FIGS. 5B and 5C, each first capacitor electrode 901 and each second capacitor electrode 902 have first sub-electrodes and second sub-electrodes, respectively. The first sub-electrodes and the second sub-electrodes have a zigzag pattern and they are alternately arranged. Compared with conventional capacitors having two big electrode plates, such arrangement can increase capacitance of the capacitors 93. No dielectric layer is required to be sandwiched between the first capacitor electrodes 901 and the second capacitor electrodes 902. Therefore, the first capacitor electrodes 901 and the second capacitor electrodes 902 are provided in a single layer and the formation steps can be reduced.

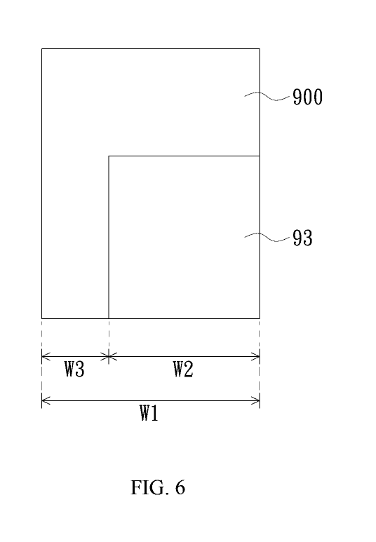

The applicant has provided new sensing methods in other patent applications (e.g. U.S. patent application Ser. No. 14/162,004 and Taiwanese Patent Application No. 102145721) to increase sensing resolution, double along one axis and quadruple for area sensing resolution. By adopting these sensing methods, even though the capacitors are not arranged as close as before, the same sensing quality of the touch screen structure can be reached. Please refer to FIG. 6, a width W1 of the sensing cell 900 is designed as twice as a width of a touch area of a touch object. If the touch object is a human finger, the width of the touch area is about 4 mm. Therefore, the width W1 of the sensing cell 900, usually designed in a shape of rectangle or a square, may be 8 mm, but is not limited to this value. The width W1 of the sensing cell 900 may range from 6 mm to 13 mm, and the width W2 of the capacitor 93 may range from 4 mm to 8 mm. The ratio of the width W2 to the width W1 is about 8/13 to 2/3. Therefore, in this example, the width W3 of the routing region for various signal lines or connecting traces ranges from 2 mm to 5 mm. In this embodiment, the M signal lines 911-91M connected to the first capacitor electrodes 901 in the same column pass the routing region. Larger routing region can accommodate wider lines or traces to avoid high resistance of the lines or traces due to small sectional area. However, it is to be noted that since the routing region is not an effective touch region, the width W3 of the routing region is designed to be similar to the width of the touch area so that the routing region will not affect sensing accuracy. It is acceptable that the width W3 is 1/2-4/5 of the width of the touch area.

For example, if the width of the touch area of the human finger is 4mm, the width W3 of the routing region may range from 2 mm to 5 mm. An area of the capacitor 93 is 64/169-16/36 of an area of the sensing cell 900, roughly speaking, about 1/3-1/2.

If the touch object is a stylus and the width of the touch area is about 1 mm-2 mm, the width W1 of the sensing cell 900 is about 6 mm and the width W2 of the capacitor 93 is about 5 mm-4.5 mm. Thus, the width W3 of the routing region is about 1 mm-1.5 mm and less than the range is disadvantageous to form the lines or traces. In another case, if the touch object is a human palm and the width of the touch area is about 20 mm, the width W1 of the sensing cell 900 is about 40 mm and the width W2 of the capacitor 93 is about 20 mm in an example. Thus, the width W3 of the routing region is about 20 mm-30 mm. In brief, the width W2 of the capacitor 93 is similar to the width of the touch area of the touch object or 0.5-4.5 times wider than the touch area of the touch object. The width W3 of the routing region is similar to, may be 1/2-3/2 of the width of the touch area. The width W1 of the sensing cell 900 is twice as the width of the touch area, or 1.5-2.5 times wider than the width of the touch area.

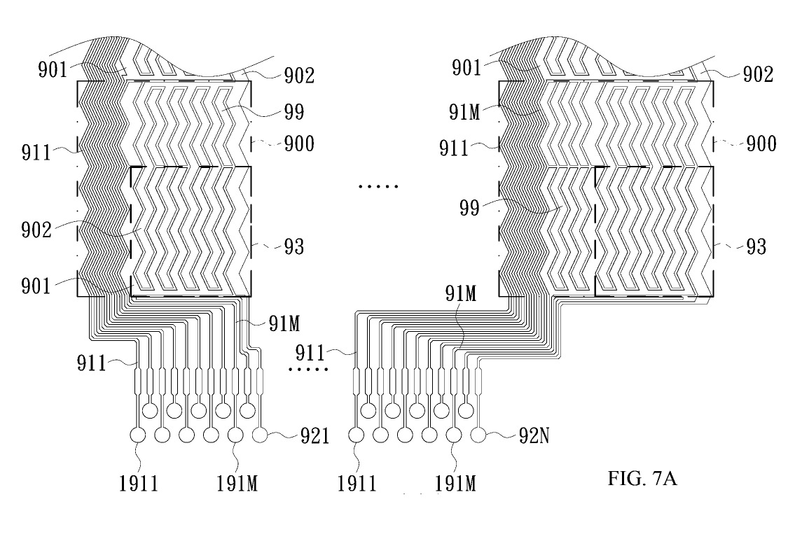

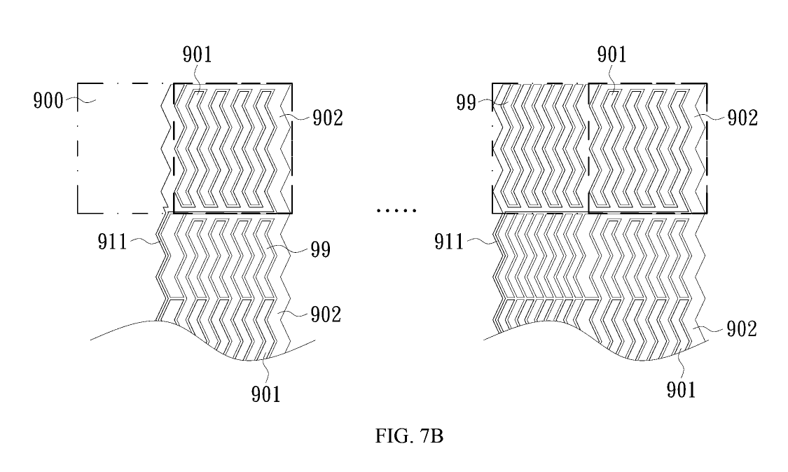

Similar to the sensor pads 42 and the connecting traces 43 in the previous embodiment, the capacitor electrodes and the signal lines can be implemented by a transparent conductive member so as to be integrated into the touch screen structure. Furthermore, dummy transparent conductive lines 99 can be disposed in an empty region where no capacitor electrodes or signal lines are formed (FIGS. 7A and 7B) to avoid visual nonuniformity.

In an embodiment, these transparent electrodes and signal lines are patterned and formed through a photolithography and etching process. Alternatively, if wider spacing between the capacitor electrodes/signal lines is acceptable, greater than 100 μm for example, the low coat screen printing method rather than the etching process can be utilized to form the capacitor electrodes and the signal lines. In other embodiments, the capacitor electrodes and the signal lines may be made of opaque material (e.g., better conductive material such as metal) through the screen printing method if the single layer capacitive touch panel is disposed in an invisible region. Thus, no dummy transparent conductive lines are required to save the conductive material usage. Other modifications such as edges of the capacitor electrodes and/or signal lines being arranged in the shielding area are also applicable.

In conclusion, the conductive member is directly formed on a surface of the transparent substrate or the surface of the backlight module to provide the single layer or other dimensional capacitive panel having sensor pads. The problems such as misalignment of the touch module occurring in the attachment or lamination procedure are avoided so that the production yield of the touch screen structure is highly improved. Furthermore, the conductive member may be optionally formed on different surfaces according to different applications so as to increase the design flexibility of the touch screen structure.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch screen structure, comprising:
a display module having a transparent substrate;
a transparent conductive member formed on a surface of the transparent substrate for providing a single layer capacitive touch panel having a plurality of sensor pads, a space between two adjacent sensor pads being greater than or equal to 100 μm; and
a control circuit electrically connected to the sensor pads for controlling the single layer capacitive touch panel.

2. The touch screen structure according to claim 1, wherein the single capacitive touch panel comprises a connecting element electrically connected to the sensor pads and the control circuit.

3. The touch screen structure according to claim 2, wherein the connecting element comprises a plurality of connecting traces formed from the transparent conductive member for electrically connecting the sensor pads and the control circuit, spacing between the connecting traces being greater than or equal to 100 μm.

4. The touch screen structure according to claim 1, further comprising a cover lens, the transparent conductive member being disposed between the cover lens and the transparent substrate, wherein air or a dielectric material is provided in a gap between the cover lens and the transparent conductive member.

5. The touch screen structure according to claim 4, wherein the gap between the cover lens and the transparent conductive member has a thickness of 0.1 mm-5 mm.

6. The touch screen structure according to claim 1, wherein the transparent substrate is a glass substrate and the transparent conductive member is made of one selected from a group consisting of an indium tin oxide material, a transparent conductive oxide material, a conductive polymer material, a conductive ink and a conductive liquid material.

7. The touch screen structure according to claim 1, further comprising a polarizing layer covering the transparent conductive member.

8. A touch screen structure, comprising:
a display module having a transparent substrate;
a transparent conductive member formed on a surface of the transparent substrate for providing a single layer capacitive touch panel having a plurality of sensor pads and a plurality of connecting traces, the connecting traces being electrically connected to the sensor pads, a space between two adjacent sensor pads being greater than or equal to 100 μm; and
a control circuit electrically connected to the sensor pads for controlling the single layer capacitive touch panel.

9. The touch screen structure according to claim 8, wherein spacing between the connecting traces is greater than or equal to 100 μm.

10. A touch screen structure, comprising:
a display module having a plurality of pixel units and a shielding area, the shielding area being disposed between any two adjacent pixel units;
a single layer capacitive touch panel having a plurality of sensor pads and a connecting element on a specific surface, the connecting element being electrically connected to the sensor pads; and
a control circuit electrically connected to the sensor pads for controlling the single layer capacitive touch panel,
wherein edges of the sensor pads are arranged in the shielding area.

11. The touch screen structure according to claim 10, wherein the sensor pads and the connecting element are formed from a transparent conductive member.

12. The touch screen structure according to claim 10, wherein edges of the connecting element are arranged in the shielding area.

13. A touch screen structure, comprising:
a backlight module;
a display module disposed relative to the backlight module;
a conductive member formed on a surface of the backlight module for providing a portion of a capacitive touch panel; and
a control circuit electrically connected to the capacitive touch panel for controlling the capacitive touch panel.

14. The touch screen structure according to claim 13, wherein the conductive member is a transparent conductive member disposed between the backlight module and the display module.

15. The touch screen structure according to claim 13, wherein the conductive member is an opaque conductive member, and the backlight module is disposed between the conductive member and the display module.
